(19) United States
(12) Patent Application Publication
(10) Pub. No.: US 2008/0024369 A1
(43) Pub. Date: Jan. 31, 2008

(54) Chip Antenna

(75) Inventor: Tetsuo Shinkai, Kyoto (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/661,339

(22) PCT Filed: Aug. 24, 2005
(86) PCT No.: PCT/JP05/15333

§ 371 Date: Sep. 17, 2007

(30) Foreign Application Priority Data
Aug. 26, 2004 (JP) 2004-247471

(51) Int. Cl. H01Q 1/38; H01Q 5/01; H01Q 9/04

(52) U.S. Cl. 343/700 MS

(57) ABSTRACT

A chip antenna according to the present invention includes a dielectric board, a power supplying conductor having a terminal part having a power supplying terminal and a conductor part that conducts to the terminal part, and a grounding electrode provided apart from the power supplying conductor, and the conductor part is inclined so that a width thereof becomes larger as it goes away from the terminal part, and distances from ends of the conductor part to the grounding electrode are asymmetric with respect to a center axis (S) of the conductor part. According to this, the chip antenna that is easy to manufacture, has a favorable antenna characteristic, and is applicable to a wide band can be provided.

### TECHNICAL FIELD

The present invention relates to a chip antenna, and more particularly to a chip antenna applicable to a wide frequency band.

### BACKGROUND ART

In recent years, portable information processing devices with a radio communication function have been remarkably spread. In radio communication in such an information processing device, an antenna is required to be mounted on the information processing device. As such an antenna, a taper-slot-shaped antenna capable of transmitting and receiving radio waves of a relatively wide range of frequencies is known. The taper slot shape is a shape having a structure in which a conductor width increases with an inclination, as shown in FIG. 21.

FIG. 22 shows a graph of a measurement result of a VSWR (Voltage Standing Wave Ratio) of the taper-slot-shaped antenna as shown in FIG. 21. The VSWR is a value indicating a degree of reflection, and “1” indicates a state of no reflection, which is a best state in view of antenna characteristic. As the VSWR becomes higher, the reflection becomes larger, which means deterioration in antenna characteristic. The graph of FIG. 22 shows a maximum value of the VSWR.

From the graph of FIG. 22, it is understood that since the VSWR value with respect to radio waves in a wide band of a frequency band 3.1 to 10.6 GHz is relatively low, this taper-slot-shaped antenna can be used for transmission and reception of radio waves of the wide frequency band of 3.1 to 10.6 GHz.

Moreover, in Patent Document 1 (Japanese Patent Application Laid-Open No. 11-163626 (Published on Jun. 18, 1999), there is disclosed a tapered-slot antenna in which corrugated structures are provided on both side ends parallel to an electromagnetic radiation direction in a conductor and these corrugated structures are asymmetric with respect to a center axis. This makes directivity of the antenna asymmetric.

However, in the taper-slot-shaped antenna, as shown in FIG. 22, the VSWR value is relatively low in the frequency band of 3.1 to 10.6 GHz, although the VSWR rises around a frequency band of 4 to 10 GHz, that is, the antenna characteristic tends to deteriorate.

Moreover, the antenna of Patent Document 1 is intended to make the directivity asymmetric, and thus, the effects of improving the VSWR characteristic and obtaining a stable antenna characteristic in a wide band (for example, 3.1 to 10.6 GHz) cannot be expected. Furthermore, the corrugated structures are complex, which makes mass production difficult.

The present invention is made in light of the above-described problems, and an object of the present invention is to provide a chip antenna stably exhibiting a favorable antenna characteristic in a wide band.

### DISCLOSURE OF THE INVENTION

In order to solve the above-described problems, a chip antenna of the present invention comprises a dielectric board made of a dielectric material, a power supplying conductor having a terminal part having a power supplying terminal and a conductor part which conducts to the terminal part, and a grounding electrode provided apart from the power supplying conductor, and is characterized in that the conductor part is inclined so that a width thereof becomes larger as the conductor part goes away from the terminal part, and two radio wave transmitting and receiving regions in which the transmission and/or reception of radio waves is performed between the conductor part and the grounding electrode are provided, and distances from ends of the conductor part to the grounding electrode in the radio wave transmitting and receiving regions are different from each other.

In this case, the distances from the ends of the conductor part to the grounding electrode are distances from the ends of the inclined portions of the conductor part to the grounding electrode.

According to the above-described constitution, the distances from the ends of the conductor part to the grounding electrode in the radio wave transmitting and receiving regions are different from each other. Since the frequency of the radio wave received or transmitted by the chip antenna depends on the distance from the end of the conductor part to the grounding electrode, by differentiating this distance, different frequency domains can be set as target. Accordingly, as compared with the conventional taper slot antenna having an axisymmetric shape, the chip antenna having high antenna sensitivity in a wade range of frequency domain can be attained.

In such a chip antenna, favorable transmission and reception is enabled regardless of orientation of the chip antenna and direction of polarization used for radio waves (vertical wave, horizontal wave and the like), which advantageously eliminates directivity.

Furthermore, manufacturing relatively easily allows the low-cost, high-performance chip antenna to be manufactured.

Moreover, the chip antenna of the present invention is characterized in that if a maximum value of the distance from the end of the conductor part to the grounding electrode in one of the radio wave transmitting and receiving regions is 10, a maximum value of the distance from the end of the conductor part to the grounding electrode in the other radio wave transmitting and receiving region is larger than 1 and smaller than 7.

By setting the distance from the end of the conductor part to the grounding electrode in this manner, an effect of improving the antenna characteristic in the whole target frequency range can be increased. If the maximum value of the distance from the end of the conductor part to the grounding electrode in one of the radio wave transmitting and receiving regions is 10, and when the maximum value of the distance from the end of the conductor part to the grounding electrode in the other radio wave transmitting and receiving region is larger than 7, the distances from the ends of the conductor part to the grounding electrode are not so different from each other, so that the effect of improving the antenna characteristic in the whole target frequency range is low. On the other hand, when the maximum value of the distance from the end of the conductor part to the grounding electrode in the other radio wave transmitting and receiving region is smaller than 1, both the radio wave transmitting and receiving regions of the conductor part are badly balanced, so that there is a possibility that the antenna characteristic cannot be stably improved.

Moreover, the chip antenna of the present invention is characterized in that the transmission and/or reception of the radio waves of frequencies of 3.1 to 10.6 GHz is performed.

Since the radio waves of the frequencies of 3.1 to 10.6 GHz are equivalent to those of a frequency band of UWB communication, a favorable antenna characteristic can be obtained in use as an antenna performing UWB communication.

Moreover, the chip antenna of the present invention is characterized in that the dielectric board and the power supplying conductor are integrally molded by insert molding in such a manner that at least a part of the conductor part is covered with the dielectric material.

According to this, as compared with a conventional manufacturing method of an antenna, the manufacturing is easier. Accordingly, mass productivity can be improved, and the low-cost chip antenna can be provided.

More specifically, in the chip antenna according to the present invention, the dielectric board and the power supplying conductor are integrally molded by insert molding in such a manner as to sandwich the power supplying conductor having the terminal part and the conductor part, and in such a manner that at least a part of the conductor part of the power supplying conductor is covered with the dielectric material of the dielectric board.

A general chip antenna needs many manufacturing processes. This makes it difficult to improve production efficiency of the chip antenna. Consequently, in the chip antenna according to the present invention, since the dielectric board and the power supplying conductor are integrally molded by insert molding as described above, the above-described process of mask working and the process of removing the mask part by etching are not required, so that manufacturing is enabled by a simple method. As the dielectric material of the dielectric board, resin can be used.

Namely, in the chip antenna according to the present invention, mass productivity is improved.

Furthermore, with the improvement of mass productivity, the cost relating to the chip antenna can be reduced, so that a low-cost chip antenna can be provided.

Moreover, since the insert molding is performed in such a manner that at least a part of the conductor part of the power supplying conductor is covered with the dielectric material, the portion covered with the dielectric material in the conductor part is not exposed outside. Therefore, the conductor part can be protected from an external environment such as oxidization.

Accordingly, endurance of the conductor part against the external environment, and endurance of the entire chip antenna against the external environment can be improved.

“Insert molding” in the present specification indicates that using dies, a metal material of the power supplying conductor and the like is placed in the dies, and the dielectric material is introduced into the dies to integrally mold the metal material of the power supplying conductor and the like, and the dielectric material.

Since the chip antenna manufactured by the manufacturing method of the chip antenna of the present invention is chip-shaped, a height from a grounding surface is lower as compared with a conventional monopole antenna, so that a thin antenna can be provided.

This allows the chip antenna of the present invention to be preferably used for thin equipment such as various types of mobile equipment, which has been actively developed in recent years.

Moreover, the chip antenna of the present invention is characterized in that the dielectric board is made of at least two dielectric materials different in relative permittivity, and each of the dielectric materials is in contact with the conductor part.

With the above-described constitution, the chip antenna which is applicable to a wider frequency band while keeping the maximum value of the VSWR low, in addition to the above-described effects, can be provided.

In the conventional taper-slot-shaped antenna, rise of the VSWR value is observed in the specific frequency band, as described above. One of the causes is reflection of an electromagnetic wave transmitted to the radiation conductor. More specifically, in a boundary surface where the relative permittivity changes, such as an outer surface of the dielectric board, reflection of the electromagnetic wave occurs. In the case, the boundary surface is a boundary between the outer surface of the dielectric board and external space to which the electromagnetic wave is radiated. In the conventional taper-slot-shaped wide-band antenna, the dielectric board is single-layered. In the case where the dielectric board is single-layered, an occurrence portion of the reflection of the electromagnetic wave is only the boundary surface between the outer surface of the dielectric board and the external space to which the electromagnetic wave is radiated, and an intensive reflected wave occurs, concentrating on a predetermined frequency. This raises the VSWR value. Consequently, according to the chip antenna of the present invention, each of the board materials is constituted to be in contact with at least the conductor part, and the board materials are different in relative permittivity.

This allows the electromagnetic wave transmitted from the power supplying line to the power supplying conductor inside of the dielectric board to be reflected in the boundary surface of each of the board materials and the outer surface of the dielectric board in accordance with the difference in the relative permittivity.

Namely, with the above-described constitution, since the at least two board materials making up the dielectric board are board materials having relative permittivity different from each other, the occurrence portion of the reflection of the electromagnetic wave is diconcentrated, and with this, the reflected waves of the respective frequencies are diconcentrated. Accordingly, the default that the strong reflected wave occurs by concentrating on the predetermined frequency, and the VSWR value in the frequency rises can be avoided.

Moreover, in this manner, in the chip antenna of the present invention, the dielectric board can be multi-layered, and even in the case of the multi-layered structure, the respective dielectric materials and the power supplying conductor can be integrally molded by insert molding with ease.

Accordingly, the chip antenna capable of easy manufacturing and applicable to a wide band of frequencies (radio waves) can be provided.

Other objects, characteristics, and excellent points of the present invention will be sufficiently understood by the following description. Moreover, the benefits of the present invention will be obvious in the following description referring to the attached drawings.

### BRIEF DESCRIPTION OF THE DRAWINGS

FIG. 1 is a plane view showing an outline of a chip antenna in an embodiment according to the present invention.

FIG. 2 is a plane view in which a conductor part is enlarged in FIG. 1.

FIG. 3 is a graph showing VSWR assumed as an antenna characteristic of a conventional chip antenna and an antenna characteristic of the chip antenna in the present embodiment.

FIG. 4 is a graph showing maximum values of the VSWR measured as the antenna characteristic of the chip antennas in the present embodiment.

FIG. 5 is a graph showing maximum values of the VSWR measured as the antenna characteristic of the chip antennas in the present embodiment.

FIG. 6 is a graph showing maximum values of the VSWR measured as the antenna characteristic of the chip antennas in the present embodiment.

FIG. 7A is a plane view showing the outline of the chip antenna in the present embodiment.

FIG. 7B is a plane view showing a comparative constitution of the chip antenna shown in FIG. 7A.

FIG. 8A is a graph showing maximum values of the VSWR measured as the antenna characteristic of the chip antennas in the present embodiment.

FIG. 8B is a graph in which the vertical axis of the graph shown in FIG. 8A is enlarged.

FIG. 9 is a graph in which average gains of the chip antennas in the present embodiment are measured.

FIG. 10 is graphs showing radiation characteristics of the conventional chip antenna.

FIG. 11 is graphs showing radiation characteristics of the chip antenna of the present embodiment.

FIG. 12 is a perspective view showing a shape of a chip antenna in another embodiment according to the present invention.

FIG. 13 is a transparent view showing a constitution of the chip antenna in the above-described another embodiment according to the present invention.

FIG. 14 is a cross-sectional view in which the chip antenna shown in FIG. 12 is cut along line A-A′.

FIG. 15 is a cross-sectional view in which the chip antenna shown in FIG. 12 is cut along line C-C′.

FIG. 16A is a plane view showing a structure of a power supplying conductor included in the chip antenna in the embodiment according to the present invention, and composed of a power supplying electrode part and a power supplying terminal part.

FIG. 16B is a perspective view of the power supplying conductor shown in FIG. 16A.

FIG. 17 is a schematic view showing a manufacturing method of the chip antenna in the embodiment according to the present invention.

FIG. 18 is a perspective view showing a modification of the structure of the chip antenna in the embodiment according to the present invention.

FIG. 19 is a cross-sectional view in which a chip antenna of another embodiment according to the present invention is cut along line A-A′.

FIG. 20 is a cross-sectional view in which the chip antenna of the above-described another embodiment according to the present invention is cut along line C-C′.

FIG. 21 is a cross-sectional view showing a constitution of a general taper-slot-shaped antenna.

FIG. 22 is a graph showing a measurement result obtained by measuring the VSWR in a band of 3.1 to 10.6 GHz as characteristic evaluation of the general taper-slot-shaped antenna.

### BEST MODE FOR CARRYING OUT THE INVENTION

A description of one embodiment of the present invention is as follows. The present invention, however, is not limited to this.

### EMBODIMENT 1

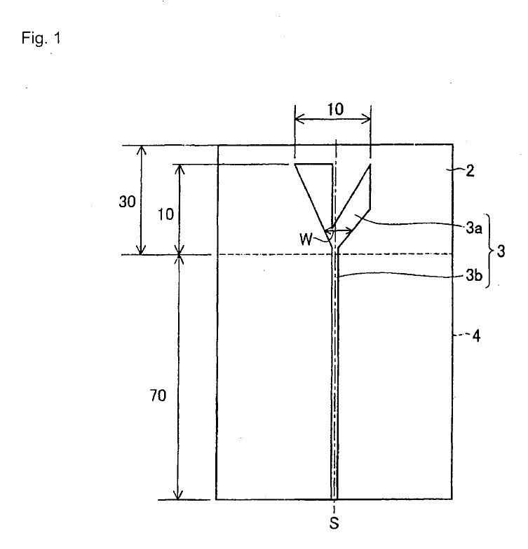

A description of the embodiment according to the present invention based on FIGS. 1 to 11 is as follows.

FIG. 1 is a plane view showing a shape of a chip antenna 1 in the present embodiment.

As shown in FIG. 1, the chip antenna 1 has a microstripline structure in which a grounding electrode 4 is arranged in a part of a back surface of a dielectric board 2, and a power supplying conductor 3 is arranged in a part of a front surface of the dielectric board 2. According to this structure, characteristic impedance of a transmission line of a high frequency wave can be kept at about 50Ω. The structure of the chip antenna 1 is not limited to this, as long as the characteristic impedance can be kept properly, and a coplanar line structure in which the grounding electrodes are formed in the front surface so as to sandwich the power supplying conductor may be employed.

The dielectric board 2 is made of a dielectric material, and is a rectangular parallelepiped board of 100 mm×50 mm and 1 mm in thickness. The grounding electrode 4 is made of a conductive material, and is formed into a film in a portion of 70 mm on the lower side of the figure on the back surface of the dielectric board 2. In order to form the metal film in a part of the dielectric board 2 in this manner, etching may be performed after the metal film is entirely formed, or the metal film may be stuck. In the power supplying conductor 3, a terminal part 3b is formed linearly with a uniform width in a central part of the portion of 70 mm on the lower side of the figure, and a conductor part 3a is formed in a section of 10×10 mm continuing to the terminal part 3b. While the conductor part 3a is formed linearly with a uniform width in the vicinity of a connection portion with the terminal part 3b, it is taper-shaped, in which a width W thereof is spreading as it goes away from the terminal part 3b. In this case, the width W indicates a distance from a right inclined portion to a left inclination of the taper shape, and even if there is a slot thereof, a length including the slot is the width W.

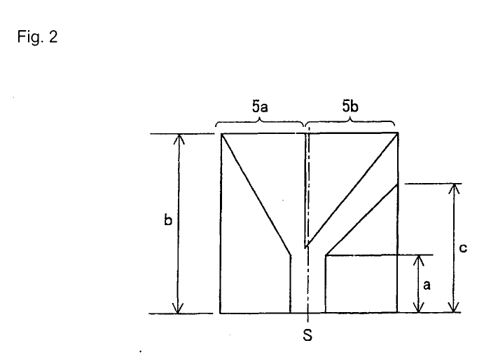

FIG. 2 shows a drawing in which the conductor part 3a is cut out. The conductor part 3a is asymmetric, in which a left radio wave transmitting and receiving region 5a and a right radio wave transmitting and receiving region 5b with respect to a center axis S are different in shape, as shown in FIG. 2. Thus, distances from inclined surfaces of the conductor part 3a to the grounding electrode 4 are different. The conductor part 3a having such a shape has three antenna lengths of an antenna length a defined by a length from the terminal part 3b to the starting of the spread, an antenna length b defined by a maximum distance between the conductor part 3a and the grounding electrode 4 in the left radio wave transmitting and receiving region 5a, and an antenna length c defined by a maximum distance between the conductor part 3a and the grounding electrode 4 in the right radio wave transmitting and receiving region 5b. In this case, a<b<c.

The length of the antenna equivalent to the length a defines an upper limit frequency. Moreover, the length of the antenna equivalent to the length b defines a lower limit frequency. The length of the antenna equivalent to the length c defines an intermediate frequency. In a frequency domain of 3.1 to 10.6 GHz band, the upper limit frequency is 10.6 GHz, the lower limit frequency is 3.1 GHz, and the intermediate frequency is 4 to 10 GHz.

That is, by designing the chip antenna 1 of the present embodiment so as to have the length c of the antenna length equivalent to the intermediate frequency of the above-described band (part where the VSWR maximum value rises in a general taper slot antenna) in addition to the length b of the antenna length defining the lower limit frequency, and the length a of the antenna length defining the upper limit frequency, the chip antenna 1 becomes an antenna applicable to the intermediate frequency, and is considered to improve the antenna characteristic in a wide band. In consideration of this, it is desirable that the length c of the antenna is designed to be applicable to 4 to 10 GHz where the VSWR becomes low.

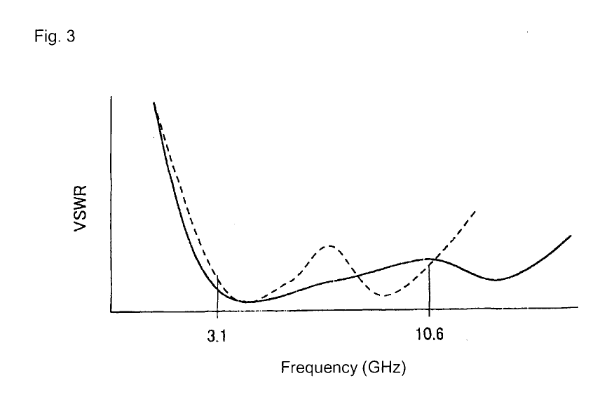

Thus, by designing the one chip antenna 1 so as to have the three kinds of antenna lengths, the antenna characteristic such that the respective lengths are adapted to the low frequency domain, intermediate frequency domain, and high frequency domain is exhibited. Accordingly, while the VSWR of the general taper-slot-shaped antenna having symmetric power supplying electrode part rises in the intermediate frequency domain, as indicated by dashed line in FIG. 3, such rise of the VSWR does not occur in the chip antenna 1 of the present embodiment, and it is assumed that a favorable antenna characteristic can be obtained in a wide range of frequency domain.

Moreover, the above-described chip antenna 1 does not have a complex structure such as a corrugated structure, and thus, is manufactured relatively easily, which advantageously enables mass production at low cost.

In the present embodiment, the conductor part 3a has a slit along the center axis S in the radio wave transmitting and receiving region 5b.

Moreover, when the transmission and reception of electromagnetic waves is performed using this chip antenna 1, an end of the terminal part 3b of the power supplying conductor 3 on the opposite side of the conductor part 3a and the grounding electrode 4 arranged on the back surface of the dielectric board 2 are connected through a cable such as a coaxial cable (not shown). At this time, an internal conductor (core) of the coaxial cable is connected to the terminal part 3b, and an external conductor (shield) of the coaxial cable is connected to a vicinity of the grounding electrode 4.

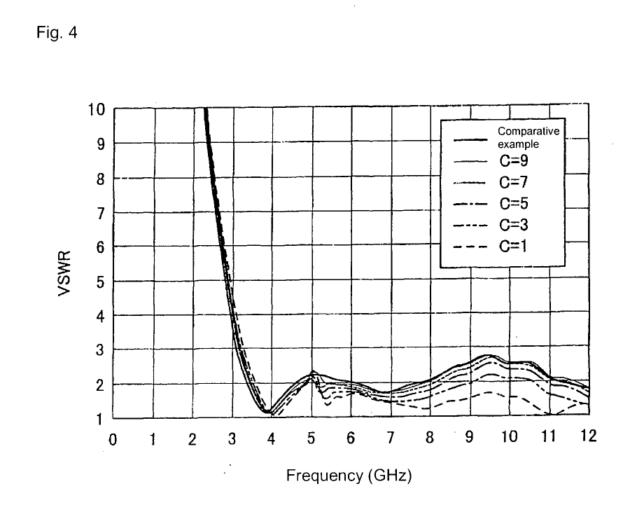

Hereinafter, with the chip antenna 1, effects on the antenna characteristic by the shape of the power supplying electrode part 3 are specifically described, based on FIGS. 4 to 6. As the chip antenna 1, chip antennas in which the shape of the radio wave transmitting and receiving region 5b is changed so that the antenna length c is 1 mm, 3 mm, 5 mm, 7 mm, and 9 mm are manufactured and experimented.

FIG. 4 is a graph showing maximum values of the VSWR measured in the frequency domain of 3.1 to 10.6 GHz band as the antenna characteristic of the chip antenna 1 in the present embodiment. Also, in FIG. 4, as a comparative example, a measurement result of a chip antenna having a symmetric, taper-slot-shaped power supplying electrode part with the antenna lengths of b=c is indicated by heavy line. As the material of the dielectric board of all the chip antennas, a material with a permittivity ∈=4.7 is used.

As indicated by heavy line in FIG. 4, with the VSWR of the chip antenna having the symmetric power supplying electrode part (general taper-slot-shaped antenna) of the comparative example, it is understood that the VSWR maximum value in the domain of the frequency band 4 to 10 GHz rises. This is because even if the antenna length a defining the upper limit frequency and the antenna length b defining the lower limit frequency are combined to make low the VSWR in the frequency domain of the 3.1 to 10.6 GHz band, the VSWR is deteriorated in the intermediate frequency part due to the properties of the taper slot antenna.

In contrast, it is understood that in the chip antenna 1 of the present embodiment, the rise of the VSWR maximum value in the domain of the frequencies 4 to 10 GHz is reduced. Particularly, as the antenna length c is decreased from 9 mm to 1 mm, the reduction in the rise of the VSWR maximum value becomes more remarkable.

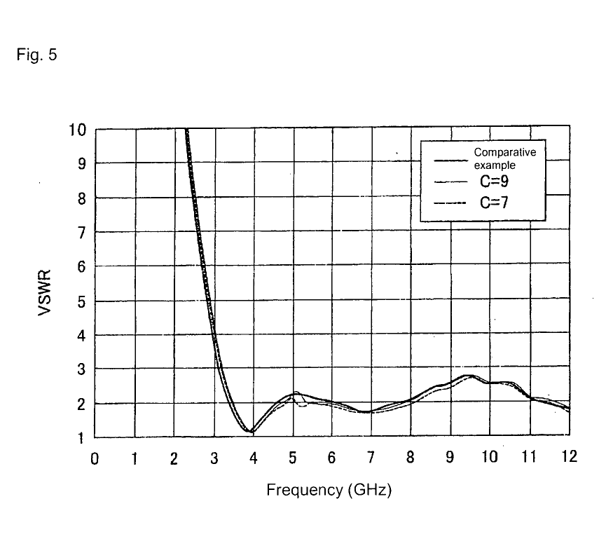

FIG. 5 is a graph showing the results of the comparative example, and the chip antennas with c of 7 mm and 9 mm extracted from the graph of FIG. 4. As shown in the same figure, when c is 7 mm and 9 mm, the VSWR is not so different from that of the symmetric power supplying electrode part. Accordingly, c is desirably shorter than 7 mm.

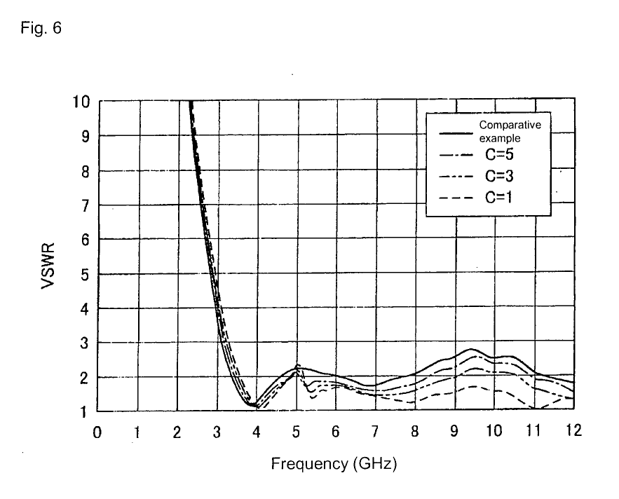

Moreover, FIG. 6 is a graph showing the results of the comparative example, and the chip antennas when c is 1, 3 and 5 mm extracted from the graph of FIG. 4. According to this, the VSWR becomes more stable as c becomes smaller, as compared with the symmetric power supplying electrode part of the comparative example. However, if c is too short, as in the case where c is 1 mm, the lower limit frequency tends to become slightly higher, and the characteristic fluctuates in the vicinity of 5 GHz. Accordingly, it can be said that when c is 3 to 5 mm, the VSWR is the most stable, and it is desirable that c is larger than 1 mm and smaller than 7 mm. In other words, when b is 10, c is desirably larger than 1, and more desirably not smaller than 3. Moreover, when b is 10, c is preferably smaller than 7, and more desirably not larger than 5.

In this case, as the reason why the rise of the VSWR maximum value in the vicinity of the frequency 3.1 GHz and in the domain of frequencies 4 to 10 GHz can be reduced in the chip antenna 1 of the present embodiment, the following are considered.

Generally, the following formula tends to be applicable to a relationship of the length of the antenna, the permittivity and the frequency.
λ=C/f√∈eff
where λ represents a length of the antenna, C represents the speed of light, f represents a frequency, and ∈ eff represents an apparent relative permittivity.

According to the present embodiment, since the speed of light and the apparent relative permittivity are constant, if the length of the antenna is changed, the frequency is dependently changed. Accordingly, the antenna having the three kinds of antenna lengths is adapted to three kinds of frequencies.

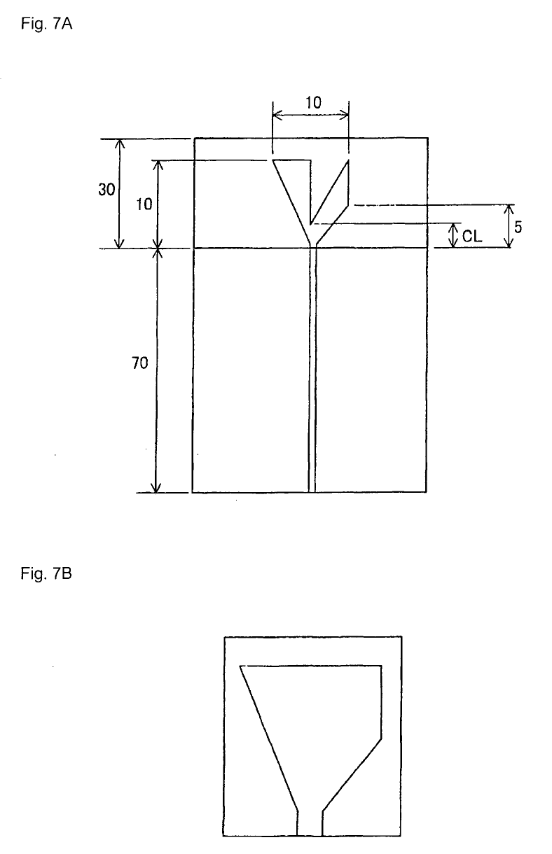

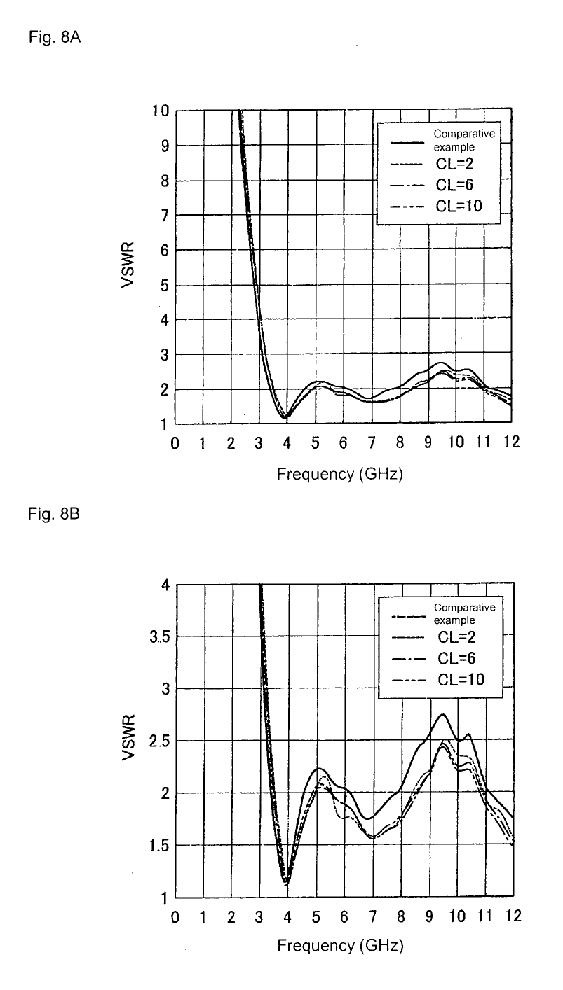

Next, in order to observe effects on the antenna characteristic by the slit portion of the conductor part 3a, with c fixed to 5 mm, a distance CL from a deepest portion of the slit to the grounding electrode 4 in the center axis S as shown in FIG. 7a is changed into 2 mm, 6 mm and 10 mm to measure the VSWR as in the above-described experiment. When CL is 10 mm, the conductor part has a shape with no slit as shown in FIG. 7b. The results are shown in FIG. 8A, and its vertical axis enlarged chart is shown in FIG. 8B. In FIGS. 8A,B, the VSWR of the chip antenna having the symmetric power supplying electrode part (general taper-slot-shaped antenna) is also shown as the comparative example.

According to FIG. 8B, the VSWR of the chip antenna 1 of the present embodiment is all more stable than the comparative example. On the other hand, the change in CL does not affect the VSWR, so that it is understood that the presence and the size of the slot do not affect the antenna characteristic.

Subsequently, radiation characteristics when a radio wave is actually radiated using the chip antenna 1 are measured. First, with the chip antennas in which c is 1 mm, 3 mm, 5 mm, 7 mm, and 9 mm, an average of gains of the frequency obtained by rotating the chip antenna 1 horizontally twice in three axes and dual polarization is measured as an average gain. The average gain is an index indicating sensitivity of an antenna, and is ideally 0. The dual polarization means that an outputted radio wave is divided into two of a V polarized wave of a vertical wave and an H polarized wave of a horizontal wave to be measured. Moreover, three axes indicate the orientations of the chip antenna 1, which means that the gain is measured in three postures where x, y, and z axes are vertical directions, respectively, if a long axis direction is the y axis, a short long axis direction is the x axis in a plane of the dielectric board 2, and a thickness direction is the z axis.

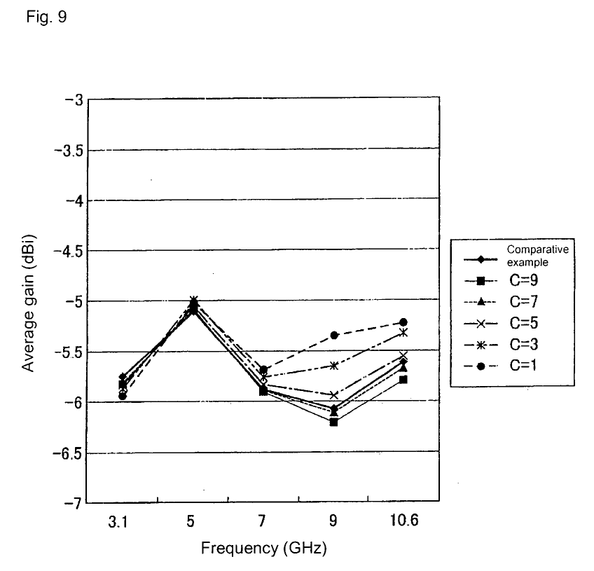

The results are shown in FIG. 9. According to this, while the average gain is not different from that of the comparative example in the case where c is 9 mm and 7 mm, the average gain becomes closer to 0 as c becomes shorter from 5 mm through 3 mm to 1 mm. Particularly, in a high frequency domain of the frequencies of 7 GHz to 10.6 GHz, the average gain is improved. This is considered to be due to the improvement of the above-described VSWR.

In the present embodiment, by setting the length of c to 1 mm to 5 mm, the antenna characteristic can be improved with a wide range of frequencies. However, the length of c necessary for exerting this effect is changed depending on the characteristics of the permittivity and the like of the dielectric board. Accordingly, the length of c is not limited to these, but may be set according to the respective chip antennas, and the frequencies of the radio waves.

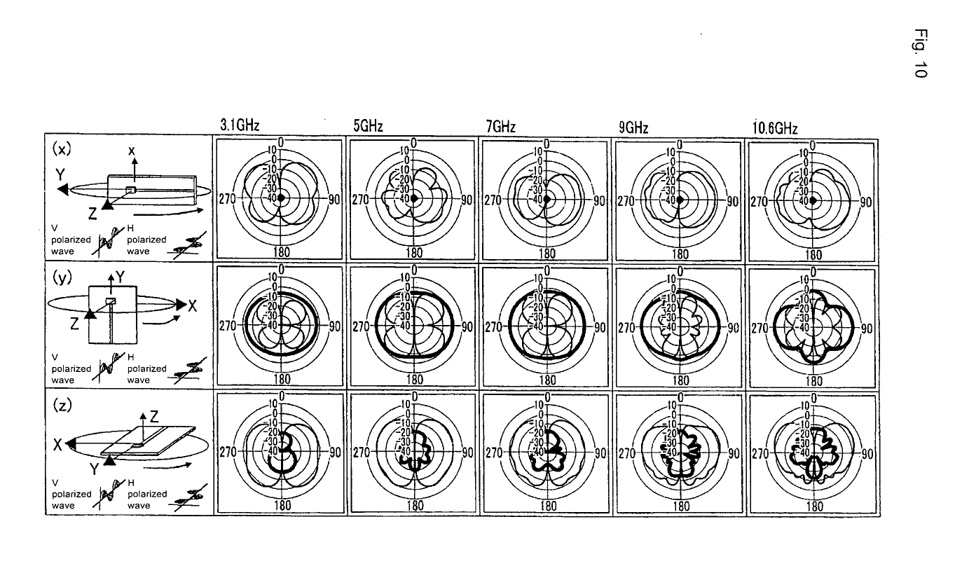

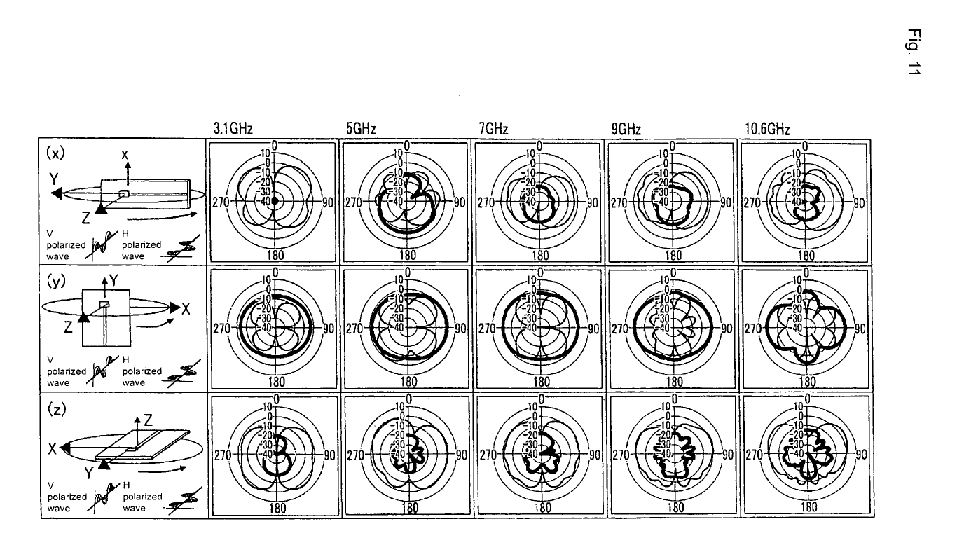

Moreover, in FIGS. 10, 11, with the chip antenna of the comparative example (FIG. 10) and the chip antenna 1 of the present embodiment with c set to 5 mm (FIG. 11), results obtained by horizontally rotating the antennas to measure a far-field radiation characteristic gain, which is an index of the directivity, in the respective postures of the three axes (the postures in which the vertical directions are the x axis (indicated by (x) in the figure), the y axis (indicated by (y) in the figure) and the z axis (indicated by (z) in the figure), respectively) are shown. In FIG. 10, reference numerals 0, 90, 180, 270 of circumferential portions denote rotation angles when the chip antenna 1 is rotated horizontally. Each of the rotation angles indicates a positional relationship between a front direction of the chip antenna 1 and a measurement device of the far-field radiation characteristic gain. That is, when the X axis is rotated (x), the rotation angle when the measurement device is on the Z axis on the front side is 0 degree, and when from this point, the measurement device is rotated at 270 degrees in an arrow direction, the position is equivalent to Y axis. Similarly, when the Y axis is rotated (y), the Z axis is a basis of 0 degree, and when the measurement device is rotated at 90 degrees, the position is equivalent to the X axis. Moreover, when the Z axis is rotated (z), the Y axis is a basis of 0 degree, and when the measurement device is rotated at 270 degrees, the position is equivalent to the X axis. Furthermore, numeric values indicated at radii of circles denote the far-field radiation characteristic gains. The V polarized wave is indicated in gray, and the H polarized wave is indicated in black. As to frequencies, the measurement is performed with 3.1 GHz, 5 GHz, 9 GHz and 10.6 GHz.

In comparison between FIGS. 10 and 11, in FIG. 10, when the vertical direction is the x axis, the far-field radiation characteristic gain of the V polarized wave is −40 dBi or lower, which is extremely low, with all the frequencies, and on the other hand, in FIG. 11, when the vertical direction is x axis, the frequency gain is improved in 5 GHz to 10.6 GHz. Accordingly, it is understood that in the chip antenna 1 with c set to 5 mm, the radio wave can be favorably received, in regardless of the direction, and regardless of the V polarized wave or H polarized wave, thereby realizing an omnidirectional antenna.

According to this, since the transmission and reception using both the vertical wave and the horizontal wave is enabled, the antenna sensitivity is stably improved in any orientation of the chip antenna.

As described above, while for convenience of description, the case where electromagnetic waves are transmitted using the chip antenna 1 is assumed and the characteristic and the like of the chip antenna are described, this characteristic and the like are similarly almost true in a case where electromagnetic waves are received using the chip antenna 1. That is, the chip antenna 1 can be used for both transmission and reception of electromagnetic waves.

### Embodiment 2

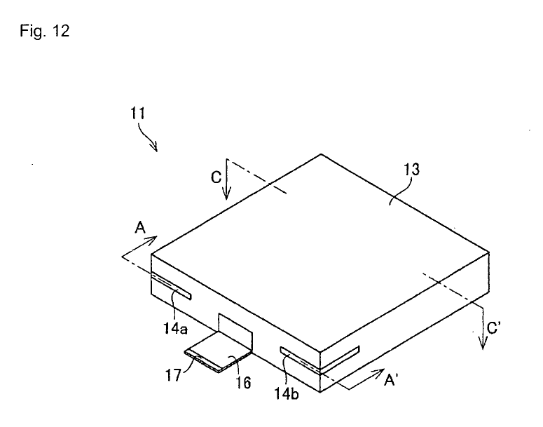

A description of another embodiment according to the present invention based on FIGS. 12 to 20 is as follows.

FIG. 12 is a perspective view showing a shape of a chip antenna 11 in the present embodiment. As shown in FIG. 12, the chip antenna 11 is a chip-shaped antenna, and an outline thereof is formed of a dielectric board 13.

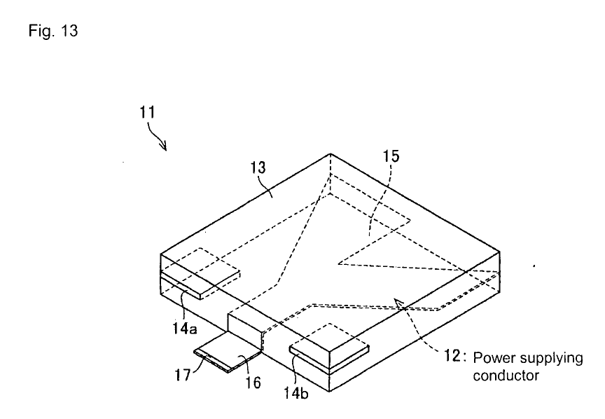

FIG. 13 is a transparent view of the chip antenna 11 shown in FIG. 12. As shown in FIG. 13, the chip antenna 11 includes a power supplying conductor 12, the dielectric board 13, and grounding electrodes 14a, 14b.

The power supplying conductor 12 includes a power supplying electrode part 15 (conductor part), and a power supplying terminal part 16 (terminal part). As shown in FIG. 13, the power supplying conductor 12 is constituted so as to be sandwiched by the dielectric board 13, and particularly, the power supplying electrode part 15 is completely covered with the dielectric board 13. A part of the power supplying terminal part 16 is exposed outside of the dielectric board 13, and an exposed end of the power supplying terminal part 16 has a power supplying terminal 17.

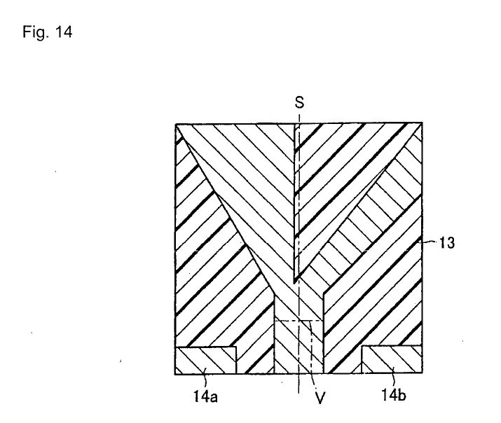

FIG. 14 is a cross-sectional view showing a state where the chip antenna 1 is cut along line A-A′ in FIG. 12. The power supplying conductor 12 is an asymmetric shape with respect to the center axis S, as shown in FIG. 14. The details of the shape of the power supplying conductor 12 are omitted, because they are the same as those in Embodiment 1.

The above-described power supplying electrode part 15 is an electrode composed of a conductor, and this shape is generally called taper slot shape. The power supplying electrode part 15 is joined to the power supplying terminal part 16 in a region V.

The power supplying terminal part 16 is a terminal composed of a conductor, and its shape is a plate. The power supplying terminal part 16 is arranged between the grounding electrodes 14a and 14b so as to be away from the respective grounding electrodes, and by being away from them, it is electrically insulated from the grounding electrodes 14a and 14b. One of both opposed ends in the power supplying terminal part 16 is joined to a region V of the power supplying electrode part 15 to be electrically connected to the power supplying electrode part 15. The other end is provided with the power supplying terminal 17, which is connected to a power supplying line not shown.

The portion of the power supplying terminal part 16 where the power supplying terminal 17 is provided is exposed outside of the dielectric board 13, as described above, and further, the exposed portion is bent as shown in FIGS. 12 and 13. The bending of the power supplying terminal 17 portion of the power supplying terminal part 16 allows the chip antenna 11 of the present embodiment to have a structure suitable for surface mounting. The power supplying terminal part 16 can be made of a metal material, for example.

The grounding electrodes 14a and 14b are electrodes each made of a conductor, and having a plane-like shape. The grounding electrodes 14a and 14b are arranged with a predetermined distance placed between the grounding electrodes 14a and 14b so that the power supplying terminal part 16 is arranged apart from, and between the grounding electrodes 14a and 14b. The grounding electrodes 14a and 14b can be each made of a metal plate material, for example.

The dielectric board 13 is made of a dielectric conductor, and is a member intervening between the power supplying electrode part 15 and the grounding electrodes 14a and 14b to fill the portion between the power supplying electrode part 5 and the grounding electrodes 14a and 14b. The outline of this dielectric board 13 is equivalent to the outline of the chip antenna 11, having a rectangular parallelepiped shape, as shown in FIG. 12.

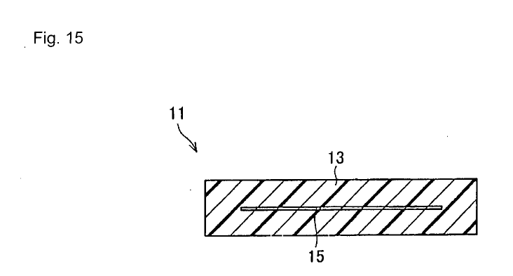

FIG. 15 is a cross-sectional view showing a state in which the chip antenna 11 is cut along line C-C′ in FIG. 12. As shown in FIG. 15, the dielectric board 13 is constituted so as to contact the power supplying electrode part 15. The dielectric board 13 has the antenna shape of the present example, using a board material with a permittivity of ∈=16. As the board material, resin is preferable. By using resin as the board material, the power supplying conductor 12 and the dielectric board 13 are integrally molded by insert molding to be manufactured. In order to perform the insert molding, resin having thermoplasticity, that is, thermoplastic curable resin is more preferable.

As the above-described resin, for example, polyether sulfone (PPS), liquid crystal polymer (LCP), syndiotactic polystyrene (SPS), polycarbonate (PC), polyethylene terephthalate (PET), epoxy resin (EP), polyimide resin (PI), polyetherimide resin (PEI), phenol resin (PF) or the like can be used.

Among the above-described resin, PPS or LCP can be manufactured so as to have high permittivity, and thus, it is preferable that PPS or LCP having high permittivity manufactured in such a manner is used.

Since the above-described chip antenna 11 has the power supplying electrode part 15 in the similar shape to the conductor part 3a of Embodiment 1, it becomes a chip antenna having high antenna sensitivity in a wide range of frequency domain.

When the transmission and reception of electromagnetic waves using this chip antenna 11, a cable such as a coaxial cable (not shown) is connected to the center of this chip antenna 11 from the grounding electrode 14a side. At this time, an internal conductor (core) of the coaxial cable is connected to the power supplying terminal 17, and an external conductor (shield) of the coaxial cable is connected to a vicinity between the grounding electrodes 14a and 14b. For this, the grounding electrodes 14a and 14b are each provided with a connector (not shown) for connecting to the coaxial cable. Instead of providing the connectors, the coaxial cable may be directly attached to the grounding electrodes 14a and 14b.

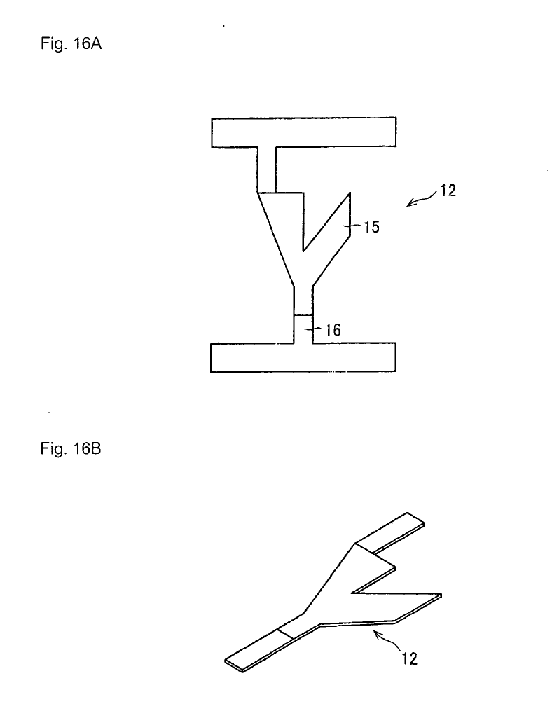

Next, based on FIGS. 16 to 18, a manufacturing method of the chip antenna 1 having the above-described structure is described.

First, a manufacturing of the power supplying conductor 12 is described based on FIGS. 16A and 16B.

With the power supplying electrode part 15, a lead frame is placed in a taper-slot-shaped cut mold, and is subjected to press working, by which the taper-slot-shaped power supplying electrode part 15 as shown in FIG. 16A can be formed. As a material making the power supplying electrode part 15, for example, gold, silver, copper or the like can be used. The power supplying terminal part 16 can be formed by solder plating. Since the power supplying electrode part 15 and the power supplying terminal part 16 are conducting, the power supplying terminal 17 can be electrically connected to the power supplying electrode part 15. FIG. 16B is a perspective view of the power supplying conductor 12 in which the connection portion of the power supplying terminal part 16 is cut out from the structure of the state of FIG. 16A.

Next, the power supplying conductor 12 manufactured in the foregoing is used and molded integrally with the dielectric board 13 by insert molding to form the chip antenna.

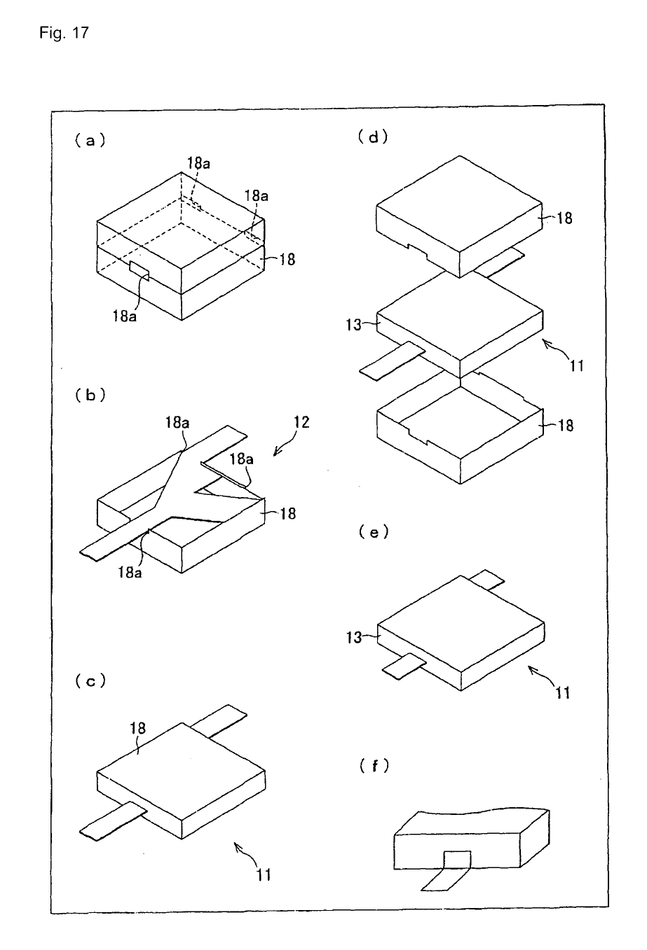

A description of a manufacturing method of the chip antenna by the insert molding based on FIGS. 17A to 17F is as follows.

In the manufacturing of the chip antenna by the insert molding, first dies 18 each having a chip shape are used to perform the insert molding. FIG. 17A is a perspective view showing the shape of the first dies 18. For convenience of the description, FIG. 17A shows only one side of the first dies 18. Accordingly, when the board material is introduced, the first die 18 on the other side is also used and set up to sandwich the power supplying conductor 12 from both sides.

As shown in FIG. 17A, the first die 18 is provided with first positioning regions 18a in predetermined positions. As one of the first positioning regions 18a, a recession formed into the shape of the power supplying terminal part 16 of the power supplying conductor 12 is exemplified. The formation of the recession allows the power supplying terminal part 16 to be fitted therein, so that the power supplying conductor 12 can be positioned. In addition to this, there may be employed one in which a rod-like protruded part is formed in a predetermined position, and the power supplying terminal part 16 is brought into contact with the protruded part to perform the positioning, and thus, the positioning region is not particularly limited as long as it can position the power supplying conductor 12.

In this manner, since the first die 18 is provided with the first positioning regions 18a, the power supplying conductor 12 shown in FIG. 16B can be precisely placed in the first die 18 by these first positioning regions 18a, so that the power supplying conductor 12 and the dielectric board 13 can be integrally molded with accuracy.

FIG. 17B is a perspective view showing a state where the power supplying conductor 12 is arranged in the first die 18. FIG. 17C is a schematic view showing a state where the power supplying conductor 12 is sandwiched by the first dies 18 on both sides. The thermoplastic board material of the dielectric board 13 is introduced into these first dies 18 through an introduction port not shown to perform the insert molding, by which the dielectric board 13 and the power supplying conductor 12 are integrated.

In FIG. 17D, the chip antenna 11 after the insert molding is shown. As shown in FIG. 17D, the board material of the dielectric board 13 is molded integrally with the power supplying conductor 12 in such a manner as to completely cover the surface of the power supplying electrode part 15 of the power supplying conductor 12.

In the antenna chip 11 molded integrally, a length of the power supplying terminal part 16 is cut to be shorter, as shown in FIG. 17E. Next, as shown in FIG. 17F, the power supplying terminal part 16 exposed to the outside of the dielectric board 13 is bent.

According to the above-described method, the chip antenna in the case where one kind of board material of the dielectric board 13 is used can be manufactured.

In the above-described maturing method, the power supplying conductor 12 having the structure shown in FIG. 16B is used, but the present invention is not limited to this.

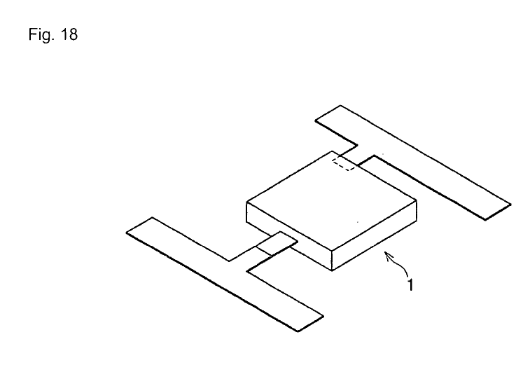

More specifically, FIG. 18 is a perspective view showing a state where the power supplying conductor 12 having the structure shown in FIG. 16A is used, and the power supplying conductor 12 and the dielectric board 12 are integrally molded by insert molding. In this manner, the power supplying conductor having the structure shown in FIG. 16A is used to manufacture the chip antenna.

Moreover, the power supplying electrode part 15 having a desired shape can be formed. Accordingly, changing the shape of the cut molding allows the power supplying electrode part 15 having the desired shape to be formed. Therefore, the chip antenna 11 having a shape preferable for a device and equipment on which the chip antenna 11 manufactured by the manufacturing method of the present invention is mounted can be provided.

By forming the dielectric board by at least two dielectric materials different in relative permittivity, the antenna characteristic is further improved.

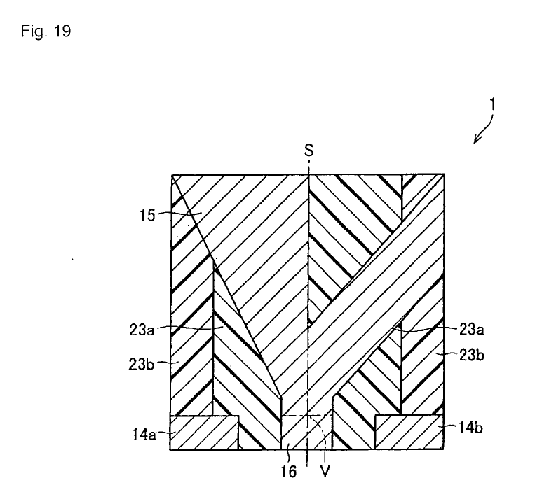

For a chip antenna having a dielectric board 23 made of such two dielectric materials, FIG. 19 is a cross-sectional view showing a state in which the chip antenna 11 is cut along line A-A′ in FIG. 12. The constitution except for the dielectric board 23 is the same as that of the above-described chip antenna 11.

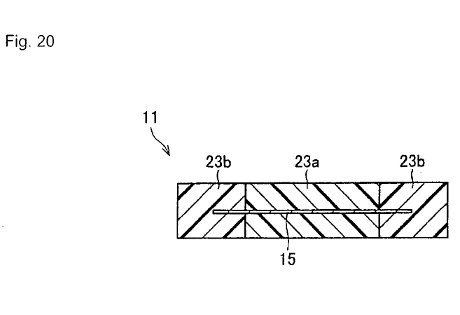

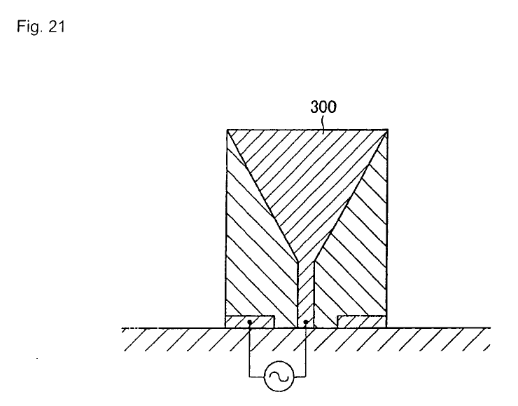

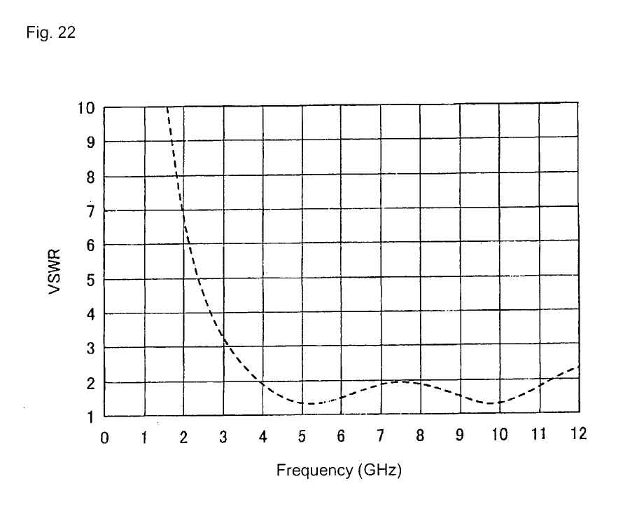

The dielectric board 23 is made of board materials 23a and 23b. The board materials 23a and 23b are described below in detail, based on FIG. 20.

FIG. 20 is a cross-sectional view showing a state where the chip antenna 11 is cut along line C-C′ in FIG. 12. As shown in FIG. 20, the dielectric board 23 is made of the board materials 23a and 23b, which are both in contact with the power supplying electrode part 15. More specifically, the board material 23a is arranged in a region including a symmetric axis S of the power supplying conductor 12, while the board material 23b does not include the symmetric axis S and is arranged in a region far from the symmetric axis S.

The board materials 23a and 23b are dielectrics having permittivities ∈23a and ∈23b respectively, and the permittivities are adjusted so that the relative permittivity is made larger in this order. More specifically, the board material 23b has the permittivity higher than that of the board material 23a so that the relative permittivity becomes higher as it becomes farther from the symmetric axis S.

The permittivity of each of the board materials is not particularly limited as long as it satisfies the above-described condition. For example, the board material 23a with the permittivity ∈=4, and the board material 23b with the permittivity ∈=16 can be used.

In the present embodiment, the chip antenna 1 having a rectangular parallelepiped shape is described. However, the present invention is not limited to this, but the shape is not limited to the rectangular parallelepiped, as long as it is a shape capable of surface mounting as described above, and for example, it may be a trapezoid.

Moreover, for the chip antenna 11 of the present invention, ceramic may be used as the board material of the dielectric board 13.

The present invention is not limited to the foregoing respective embodiments, but various modifications can be made in the scope indicated in claims, and embodiments obtained by combining the technical means disclosed in the different embodiments respectively are also included in the technical scope of the present invention.

### INDUSTRIAL APPLICABILITY

The chip antenna according to the present invention can be manufactured easily, and is applicable to a wide band of 3.1 to 10.6 GHz or the like, for example. Accordingly, it can be widely applied to handheld equipment such as a portable telephone, PDA, PC card radio, CF (compact flash (trademark)) radio, SD card radio, IEEE1394 radio, and USB radio, for example.

1. A chip antenna comprising:
a dielectric board made of a dielectric material;
a power supplying conductor having a terminal part having a power supplying terminal and a conductor part which conducts to said terminal part; and
a grounding electrode provided apart from said power supplying conductor, characterized in that:
said conductor part is inclined so that a width thereof becomes larger as the conductor part goes away from the terminal part; and
two radio wave transmitting and receiving regions in which the transmission and/or reception of radio waves is performed between said conductor part and said grounding electrode are provided, and distances from ends of the conductor part to the grounding electrode in said radio wave transmitting and receiving regions are different from each other.

2. The chip antenna according to claim 1, characterized in that if a maximum value of the distance from the end of the conductor part to the grounding electrode in one of the radio wave transmitting and receiving regions is 10, a maximum value of the distance from the end of the conductor part to the grounding electrode in the other radio wave transmitting and receiving region is larger than 1 and smaller than 7.

3. The chip antenna according to claim 1, characterized in that the transmission and/or reception of the radio waves of frequencies of 3.1 to 10.6 GHz is performed.

4. The chip antenna according to claim 1, characterized in that said dielectric board and said power supplying conductor are integrally molded by insert molding in such a manner that at least a part of said conductor part is covered with said dielectric material.

5. The chip antenna according to claim 1, characterized in that said dielectric board is made of at least two dielectric materials different in relative permittivity, and each of the dielectric materials is in contact with said conductor part.

6. The chip antenna according to claim 2, characterized in that the transmission and/or reception of the radio waves of frequencies of 3.1 to 10.6 GHz is performed.

7. The chip antenna according to claim 2, characterized in that said dielectric board and said power supplying conductor are integrally molded by insert molding in such a manner that at least a part of said conductor part is covered with said dielectric material.

8. The chip antenna according to claim 3, characterized in that said dielectric board and said power supplying conductor are integrally molded by insert molding in such a manner that at least a part of said conductor part is covered with said dielectric material.

9. The chip antenna according to claim 2, characterized in that said dielectric board is made of at least two dielectric materials different in relative permittivity, and each of the dielectric materials is in contact with said conductor part.

10. The chip antenna according to claim 3, characterized in that said dielectric board is made of at least two dielectric materials different in relative permittivity, and each of the dielectric materials is in contact with said conductor part.

11. The chip antenna according to claim 4, characterized in that said dielectric board is made of at least two dielectric materials different in relative permittivity, and each of the dielectric materials is in contact with said conductor part.
